(19) United States
(12) Patent Application Publication
(10) Pub. No.: US 2009/0313895 A1
(43) Pub. Date: Dec. 24, 2009

(54) PROCESS FOR OBTAINING A HYDROCARBON-ENRICHED FRACTION FROM A GASEOUS FEEDSTOCK COMPRISING A HYDROCARBON FRACTION AND CARBON DIOXIDE

(76) Inventors: Petrus Paulus Antonius Catharina Pex, Le Petten (NL); Arian Nijmeijer, Amsterdam (NL)

Correspondence Address: SHELL OIL COMPANY, P O BOX 2463, HOUSTON, TX, 772522463, US

(21) Appl. No.: 12/440,666

(22) PCT Filed: Sep. 10, 2007
(86) PCT No.: PCT/EP2007/059434

§ 371 Date: Jun. 17, 2009

(30) Foreign Application Priority Data
Sep. 12, 2006 (EP) 06120511.8

(51) Int. Cl. C01B 3/56

(52) U.S. Cl. 48/127.3

(57) ABSTRACT

The present invention provides a process for obtaining a hydrocarbon-enriched fraction from a gaseous feedstock comprising a hydrocarbon fraction and carbon dioxide, which process comprises the steps of: providing a membrane having a retentate side and a permeate side; and contacting the feedstock with the retentate side of the membrane, obtaining a hydrocarbon-enriched fraction at the permeate side of the membrane, wherein the membrane is an organic modified meso-porous membrane.

### FIELD OF THE INVENTION

The present invention provides a process for obtaining a hydrocarbon-enriched fraction from a gaseous feedstock comprising a hydrocarbon fraction and carbon dioxide.

### BACKGROUND OF THE INVENTION

Natural gas is a source of gaseous hydrocarbons such as methane, ethane and propane. Natural gas is typically produced from underground reservoirs. Such reservoirs may comprise non-hydrocarbon components such as for instance carbon dioxide, hydrogen sulphide and water. When the natural gas is withdrawn from the reservoir it contains these components. The natural gas is treated to remove the non-hydrocarbon components before it is transported or further processed. In recent years the exploration of natural gas reservoirs comprising over 50 mol % of carbon dioxide has been investigated. Such exploration would require the removal of substantial amounts of carbon dioxide from the produced natural gas.

Processes for the removal of carbon dioxide from gas and in particular from natural gas streams are known in the art. Generally, natural gas purification processes are based on the absorption of carbon dioxide using a suitable absorbent. Examples of absorption processes are for instance described in A. L. Kohl and F. C. Riesenfeld, Gas Purification, Gulf Pub. Co., Book Division, Houston, 1985 and include processes like ADIP and Sulfinol.

In EP 1474218 A1 a process is disclosed for removing carbon dioxide and optionally hydrogen sulphide and/or COS from a natural gas stream containing these components by washing the gas with an aqueous washing solution containing water, sulfolane and a secondary or tertiary amine derived from ethanolamine. The natural gas stream of EP 1474218 A1 comprises between 1 and 45 mol % of carbon dioxide. In the process of EP 1474218 A1, carbon dioxide is removed from the main gas stream. However, when the natural gas comprises carbon dioxide in amounts exceeding 50 mol %, it becomes increasingly desirable to remove the gaseous hydrocarbons from the main stream rather than the carbon dioxide.

US 2006/0079725 A1 discloses a molecular sieve membrane which had been modified by adsorption of a modifying agent such as ammonia to obtain a modified molecular sieve membrane. The known molecular sieve membrane selectively permeates carbon dioxide to hydrocarbons.

### SUMMARY OF THE INVENTION

There is a need in the art for a process that will allow for the removal of gaseous hydrocarbons from feedstocks comprising significant amounts of carbon dioxide.

In accordance with the present invention there is provided a process for obtaining a hydrocarbon-enriched fraction from a gaseous feedstock comprising a hydrocarbon fraction and carbon dioxide, which process comprises the steps of:

providing a membrane having a retentate side and a permeate side; and

contacting the feedstock with the retentate side of the membrane,

obtaining a hydrocarbon-enriched fraction at the permeate side of the membrane, wherein the membrane is an organic modified meso-porous membrane which selectively permeates hydrocarbons to carbon dioxide.

In the specification and the claims the term gaseous feedstock is used to refer to a feedstock that is gaseous under process conditions. An organic modified meso-porous membrane is a meso-porous matrix material with comprised therein an organic compound.

It has now surprisingly been found that the presence of an organic compound, e.g. polyethyleneimine, in the membrane promotes the transport of hydrocarbons and in particular methane through the membrane when the membrane is contacted with a mixture comprising hydrocarbons and carbon dioxide. Consequently, it has been found that gaseous hydrocarbons and in particular methane can be selectively removed from a feedstock comprising the gaseous hydrocarbons and carbon dioxide using an organic modified meso-porous membrane. In contrast to prior art processes in which carbon dioxide is selectively removed from a feedstock comprising a hydrocarbon fraction and carbon dioxide, the process according to the present invention allows for the selective removal of the gaseous hydrocarbon.

### DETAILED DESCRIPTION OF THE INVENTION

The present invention provides a process for obtaining a hydrocarbon-enriched fraction from a gaseous feedstock comprising a hydrocarbon fraction and carbon dioxide. In the process according to the invention, the feedstock is contacted with a membrane. The membrane provided in the process according to the invention is an organic modified meso-porous membrane, preferably an organic modified ceramic meso-porous membrane. An example of such a membrane, i.e. a PEI modified MCM-48 is for instance described in P. Kumar, S. Kim, J. Ida, V. Guilants and J. Lin, “PEI/MCM-48 Composite Membranes for Carbon Dioxide Separation”, page 101, Book of Abstracts, ICIM9—Norway, Jun. 25-29, 2006, which is hereby included by reference.

A membrane is a barrier preventing hydrodynamic flow, while allowing preferential transport of one or more components between fluids at either side of the barrier. Without being bound to a specific theory it is proposed that the presence of an organic compound in the membrane promotes the transport of hydrocarbons and in particular methane when the membrane is contacted with a mixture comprising hydrocarbons and carbon dioxide. Therefore, it is the hydrocarbon fraction that is preferentially transported across the membrane from the retentate side of the membrane to the permeate side of the membrane. The transport rate of hydrocarbons through the membrane and the selectivity of hydrocarbons over carbon dioxide may typically depend on process conditions such as feedstock pressure, temperature and trans-membrane pressure drop. Trans-membrane pressure drop is the pressure difference between the retentate side of the membrane and the permeate side of the membrane.

At the permeate side of the membrane a hydrocarbon-enriched permeate is obtained, while the retentate obtained from the retentate side of the membrane is a hydrocarbon depleted retentate, all compared to the hydrocarbon content of the feedstock.

The membrane may consist of a single membrane layer or it may be a composite of more than one membrane layer or of a porous support layer and one or more membrane layers. Preferably, the membrane comprises a meso-porous ceramic matrix material. It will be appreciated that such matrix materials allow for the inclusion of an organic compound. More preferably, the membrane comprises a matrix material having an average pore diameter, i.e. before inclusion of an organic compound, in the range of from 0.5 to 50×10⁻⁹ m, more preferably of from 0.75 to 10×10⁻⁹ m, even more preferably of from 1 to 5×10⁻⁹ m. The pores may have any form, for instance round or slit-shaped. Average pore diameter of the meso-porous matrix material is the average pore diameter of the meso-porous matrix material in the membrane layer determining the separation properties. It will therefore be appreciated that the ranges for the average pore diameter, as mentioned hereinabove, do not apply to e.g. the porous support layer.

The meso-porous matrix material in the membrane provided for in the process according to the invention may for example comprise ceramic material such as silica, alumina, titania, silica-alumina, zirconia or combinations thereof. When the meso-porous matrix material is a meso-porous ceramic matrix material, the ceramic material may be predominately crystalline, semi-crystalline or amorphous. Preferably, the meso-porous ceramic matrix material comprises a zeolite material or a MCM (Mobil Composition of Matter) material, more preferably a M41S type MCM material. Examples of suitable M41S type MCM materials are MCM-41 and MCM-48.

Preferably, the membrane has a porous support layer. The porous support layer may comprise a metal, ceramic or polymer. Preferably, the porous support layer is a refractory oxide support layer or a porous metal support layer, more preferably alumina, titania, zirconia or porous stainless steel. Such porous support layers are typically used to provide mechanical stability.

The membrane may be used in any suitable configuration known in the art, for example hollow fibre, tubular, spiral wound or as flat sheet.

The organic modified meso-porous membranes are membranes with incorporated in the membrane structure an organic compound. Preferably, the organic compound is comprised in the pores of a meso-porous matrix material, or on the pore wall of the pores in the meso-porous matrix material. Such an organic compound may be an amphiphilic organic compound, usually a surfactant, a polymer or oligomers. The latter two may be grafted onto the meso-porous material. Preferably, the organic compound is an amino-organic compound. Suitable examples of amino-organic compounds include polyethyleneimine.

The membrane selectively permeates hydrocarbons to carbon dioxide. Preferably, the membrane selectively permeates hydrocarbons to carbon dioxide with a permselectivity of at least 2, more preferably of at least 10, even more preferably of at least 30. Permselectivity is the ratio of the hydrocarbon permeability to the carbon dioxide permeability across the membrane. Preferably, the membrane preferentially transports hydrocarbons over carbon dioxide with a permselectivity in the range of from 2 to 150, more preferably of from 10 to 150, even more preferably 30 to 150.

At the permeate side of the membrane, a hydrocarbon-enriched fraction is obtained as permeate. Preferably, the permeate comprises in the range of from 50 to 100 mol % of hydrocarbons, more preferably of from 70 to 99 mol %, based on the total permeate. Preferably, the permeate comprises 50 to 100 mol % of methane, more preferably of from 70 to 99 mol %, based on the total permeate. It will be appreciated that from the retentate side of the membrane a hydrocarbon-depleted retentate, i.e. depleted in those hydrocarbons that are preferentially transported across the membrane, may be obtained. Hydrocarbon content in the retentate may depend on the hydrocarbon content and type of hydrocarbon present in the feedstock, membrane surface area en contact time of the feedstock with the membrane.

The obtained hydrocarbon-depleted retentate can be removed form the process or may be recycled to the membrane as part of the feedstock.

The feedstock may be any feedstock comprising a hydrocarbon fraction and carbon dioxide that is gaseous under process conditions. Preferably, the feedstock comprises C1 to C4 hydrocarbons, such as one or more of methane, ethane, ethylene, propane, propylene, butane or butylenes, more preferably the feedstock comprises methane. Examples of suitable feedstocks include natural gas, associated gas, gas produced by coal gasification and Fischer-Tropsch tail gas. It will be appreciated that the feedstock may comprise substantial amounts of one or more other non-hydrocarbon components, such as nitrogen, hydrogen sulphide, carbon monoxide and water.

Preferably, the feedstock comprises a hydrocarbon fraction of in the range of from 1 to 50 mol %, more preferably of from 5 to 50 mol %, even more preferably 10 to 40 mol % based on the total feedstock.

The feedstock also comprises carbon dioxide. Typically, the carbon dioxide content in the feedstock is at least 50 mol %, typically in the range of from 50 to 90 mol %, more typically of from 50 to 80 mol % based on the total feedstock.

The feedstock may, preferably, further comprise water. Preferably, the feedstock comprises in the range of from 0.01 to 10 mol % of water.

The feedstock may be contacted with the meso-porous membrane at any suitable temperature or pressure. Preferably, the feedstock is contacted with the meso-porous membrane at a temperature in the range of from 0 to 150° C., preferably of from 50 to 120° C., more preferably of from 70 to 100° C. Preferably, the feedstock is contacted with the meso-porous membrane at a pressure in the range of from 0.1 to 15 MPa (absolute), more preferably 1 to 10 MPa (absolute). Preferably, the feedstock is contacted with the meso-porous membrane at a trans-membrane pressure in the range of from 0.1 to 15 MPa (absolute), more preferably in the range or from 0.5 to 5 MPa (absolute). At the permeate side of the membrane, a vacuum or sweep gas may be applied to maintain the trans-membrane pressure.

1. Process for obtaining a hydrocarbon-enriched fraction from a gaseous feedstock comprising a hydrocarbon fraction and carbon dioxide, which process comprises the steps of:
providing a membrane having a retentate side and a permeate side:
contacting the feedstock with the retentate side of the membrane; and
obtaining a hydrocarbon-enriched fraction at the permeate side of the membrane, wherein the membrane is an organic modified porous membrane which selectively permeates hydrocarbons to carbon dioxide comprising a ceramic matrix material having an average pore diameter in the range of from 0.5 to 50×10⁻⁹ m and an amino-organic compound.

2. Process according to claim 1, wherein the matrix material has an average pore diameter in the range of from 0.75 to 10×10⁻⁹ m.

3. Process according to claim 2, wherein the porous ceramic matrix material comprises a zeolite or a MCM material.

4. Process according to claim 1, wherein the amino-organic compound is polyethyleneimine.

5. Process according to claim 1, wherein the hydrocarbon fraction of the feedstock comprises methane based on the total feedstock.

6. Process according to claim 1, wherein the feedstock further comprises water.

7. Process according to claim 1, wherein the feedstock is contacted with the membrane at a temperature in the range of from 0 to 150° C.

8. Process according to claim 1, wherein the feedstock is contacted with the porous ceramic membrane at a pressure in the range of from 0.1 to 15 Mpa (absolute).

9. Process according to claim 1, wherein a hydrocarbon-depleted retentate is obtained from the retentate side of the membranes.

10. Process according to claim 1, wherein the matrix material has an average pore diameter in the range of from 1 to 5×10⁻⁹ m.

11. Process according to claim 2, wherein the porous ceramic matrix material comprises a MCM material.

12. Process according to claim 2, wherein the porous ceramic matrix material comprises a M41S type MCM material.

13. Process according to claim 2, wherein the porous ceramic matrix material comprises a MCM-41.

14. Process according to claim 2, wherein the porous ceramic matrix material comprises a MCM-48.

15. Process according to claim 1, wherein the hydrocarbon fraction of the feedstock comprises methane, in the range of from 5 to 50 mol % of methane

16. Process according to claim 1, wherein the hydrocarbon fraction of the feedstock comprises methane, in the range of from 10 to 40 mol % of methane based on the total feedstock.

17. Process according to claim 1, wherein the feedstock is contacted with the membrane at a temperature in the range of from 50 to 120° C.

18. Process according to claim 1, wherein the feedstock is contacted with the membrane at a temperature in the range of from 70 to 100° C.

19. Process according to claim 1, wherein the feedstock is contacted with the porous ceramic membrane at a pressure in the range of from 1 to 10 Mpa (absolute).
